(19) United States
(12) Patent Application Publication
(10) Pub. No.: US 2011/0273160 A1
(43) Pub. Date: Nov. 10, 2011

(54) AC VOLTAGE REGULATOR

(76) Inventor: Rodney W. Scuka, McHenry, IL (US)

(21) Appl. No.: 12/776,985

(22) Filed: May 10, 2010

(51) Int. Cl. G05F 3/04

(52) U.S. Cl. 323/312

(57) ABSTRACT

A voltage regulator includes a source port configured to be coupled to a power source and a load port configured to be coupled to a load. The voltage regulator also includes a constant current source circuit in electrical communication with the source port and the load port configured to regulate current flowing between the source port and the load port. Current flows in both a positive direction and a negative direction between the source port and the load port, and the constant current source circuit regulates the current that flows in the positive direction and the current that flows in the negative direction.

### BACKGROUND

1. Field

This application relates to voltage regulators. Specifically, this application relates to a voltage regulator that regulates an AC voltage.

2. Description of the Related Art

Voltage regulators are electrical circuits utilized to regulate unregulated voltage sources. For example, a DC-to-DC (direct current-to-direct current) voltage regulator circuit may be utilized to convert a loosely regulated voltage produced by an automobile alternator into a tightly regulated voltage for operating accessories, such as MP3 players, mobile phones, and the like. An AC-to-DC (alternating current-to-direct current) voltage regulator may be utilized to convert the loosely regulated AC line voltage found in a home to a regulated DC voltage for an appliance, such as a laptop computer. An AC-to-AC regulator may be utilized to convert the loosely regulated AC line voltage found in a home to a regulated AC voltage suitable for powering, for example, a desktop computer.

A typical AC-to-AC voltage regulator operates by first converting the loosely regulated AC line voltage into a DC voltage. The DC voltage may be regulated. The DC voltage is then converted back into an AC voltage via, for example, an inverter circuit. One problem, however, with such a voltage regulator is that a relatively high number of components are required. The high number of components makes it difficult to fit such a circuit into a confined space, such as an electrical junction box.

### SUMMARY

In one aspect, a voltage regulator includes a source port configured to be coupled to a power source and a load port configured to be coupled to a load. The voltage regulator also includes a constant current source circuit in electrical communication with the source port and the load port configured to regulate current flowing between the source port and the load port. Current flows in both a positive direction and a negative direction between the source port and the load port. The constant current source circuit regulates the current that flows in the positive direction and the current that flows in the negative direction.

### BRIEF DESCRIPTION OF THE DRAWINGS

The accompanying drawings are included to provide a further understanding of the claims and are incorporated in and constitute a part of this specification.

FIG. 1 is a block diagram of an exemplary embodiment of a voltage regulator;

FIG. 2 is a schematic diagram of an exemplary voltage regulator;

FIGS. 3A and 3B illustrate voltage waveforms of the input voltage and output voltage of the exemplary voltage regulator of FIG. 1; and

FIGS. 4A and 4B illustrate current waveforms flowing through a load coupled to the voltage regulator and current waveforms flowing through an exemplary constant current source circuit of the exemplary voltage regulator of FIG. 2.

### DETAILED DESCRIPTION

The embodiments below describe an exemplary voltage regulator configured to generate a substantially constant peak-to-peak voltage and RMS (root-mean-square) voltage from a power source that exhibits significant variations in output voltage.

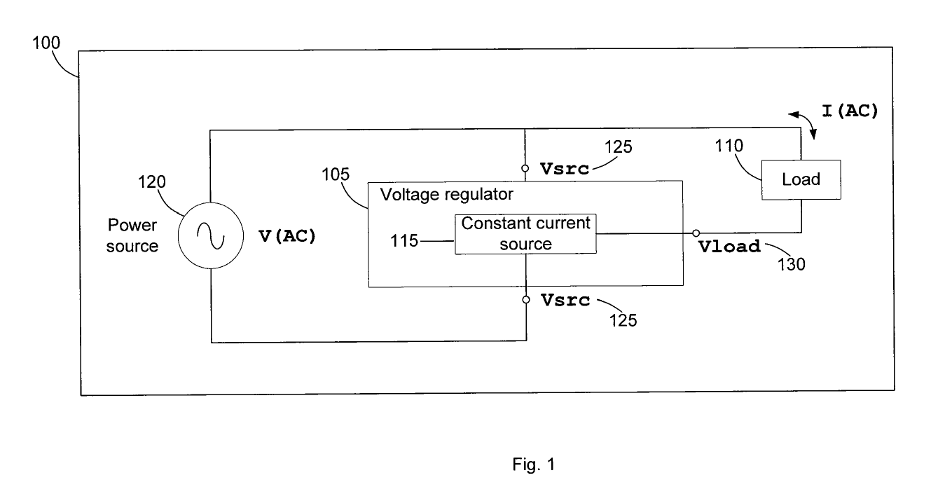

FIG. 1 is a schematic of an exemplary voltage regulator block diagram 100. Shown are a voltage regulator 105, a load 110, and a power source 120. The power source 120 corresponds to a source of AC (alternative current) voltage. In one embodiment, the power source 120 represents the line voltage provided by a power utility company. For example, line voltage may be anywhere between 150 Volts p-p (peak-to-peak) to 360 Volts p-p and may be generally sinusoidal in nature. The power source 120 may be loosely regulated. That is, the voltage provided by a given power utility company may vary, for example, due to loading variation on the power line.

The load 110 is a device that requires a regulated source of power. More specifically, the load 110 represents the impedance measured across input power terminals of the device. The impedance of the load 110 may be substantially resistive, although the load 110 may have indicative and/or reactive components. In one implementation, the load 110 represents the impedance of a timer mechanism (not shown), such as a timer for actuating a sprinkler system or to turn on equipment. The timer may be configured to operate from a fixed AC line voltage, such as the 120 Volt RMS standard line voltage utilized in the United States.

The voltage regulator 105 includes a source port 125 for coupling to the power source 120 and an output port 130 for coupling to the load 110. The voltage regulator 105 is configured to convert voltage provided by the power source 120 into a voltage suitable for operating the load 110. For example, the voltage regulator 105 may convert power line voltages provided in different countries, such as 120 Vrms and 240 Vrms, into a regulated voltage suitable for operating the load 110. The voltage that operates the load 110 may be substantially constant. As such, the voltage regulator 105 also operates to regulate power line voltage variations that may occur, for example, due to loading variations on the power line. The voltage regulator 105 includes a constant current source circuit 115 configured to regulate current flowing through the load 110, which in turn regulates voltage across power terminals of the load 110.

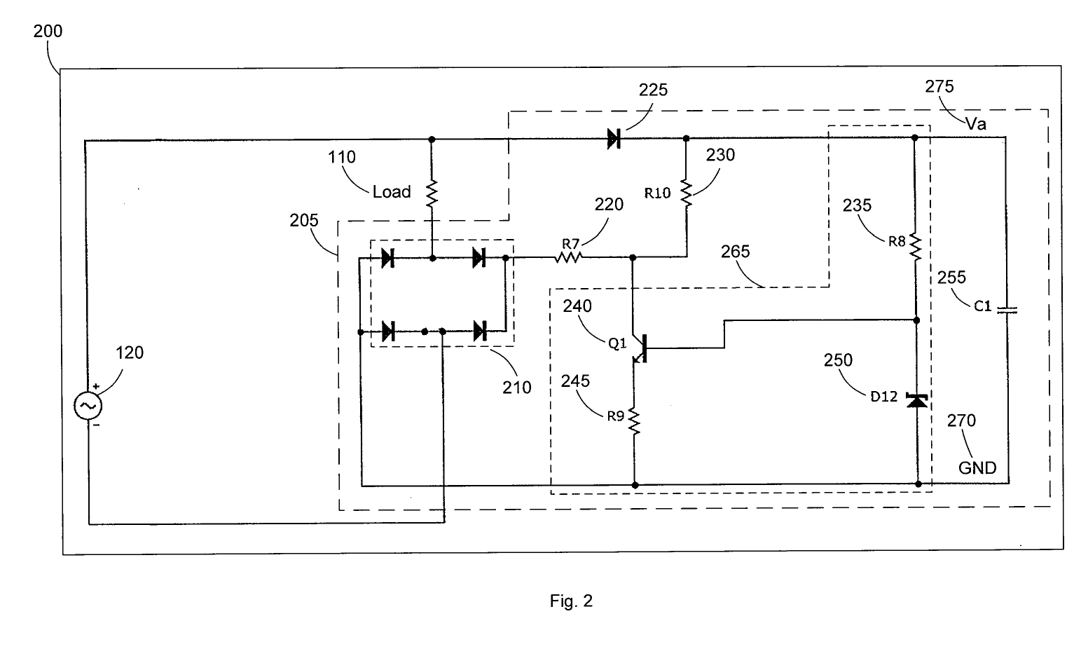

FIG. 2 is a schematic 200 that includes an exemplary voltage regulator circuit 205 that may represent circuitry within the voltage regulator 105, described above. The voltage regulator circuit 205 includes a bridge-rectifier subcircuit 210, and a constant-current-source subcircuit 265. The voltage regulator circuit 205 also includes an AC-to-DC converter circuit that includes a diode 225 and capacitor 255 that cooperate to convert AC voltage provided by the power source 120 to a DC voltage across the capacitor at nodes Va 275 and GND 270 for operating the constant-current-source sub circuit 265.

The constant-current-source sub circuit 265 implements an emitter follower circuit that includes transistor Q1 240, resistor R7 220, resistor R8 235, resistor R9 245, resistor R10 230, and zener diode D12 250. The first and the second ends of resistor R8 235 are coupled to node Va 275 and to the cathode of zener diode D12 250, respectively. The anode of zener diode D12 250 is coupled to node GND 270. The cathode of zener diode D12 250 is also coupled to the base of transistor Q1 240. The emitter of transistor Q1 is coupled to a first end of resistor R9 245. The second end of resistor R9 245 is coupled to node GND 270.

In operation, resistor R8 235 and zener diode D12 250 cooperate to produce a substantially constant reference voltage at the base of transistor Q1 240. When the voltage at the collector of transistor Q1 240 exceeds the reference voltage, current will begin to increase across resistor R9 245 until the voltage across resistor R9 245 substantially equals the reference voltage at the base of transistor Q1 240. From this point on, the voltage across resistor R9 245 will remain substantially constant, resulting in a substantially constant current flowing through resistor R9 245. By virtue of the gain of the transistor, most of this current is sourced from the collector of transistor Q1 240. In other words, the current flowing into the collector of transistor Q1 240 will be substantially the same as the current flowing out of the emitter of transistor Q1 240 and through resistor R9 245.

The amount of current flowing into the collector of transistor Q1 240 is dependent on the zener voltage of zener diode D12 250 and the resistance of resistor R9 245. In one implementation, the resistance of resistor R8 235 is 27 KOhms, the zener voltage of zener diode D12 250 is about 5.6 Volts, and the resistance of resistor R9 245 is 410 ohms. In this configuration, the current flowing into the collector of transistor Q1 240 is approximately 12 mA when transistor Q1 240 is in a linear mode of operation.

The current flowing into the collector of transistor Q1 240 is equal to the sum of the current flowing through resistor R10 230 and the current flowing through resistor R7 220. The current flowing through resistor R7 220 is equal to the magnitude of the current flowing through the load 110. The rectifier circuit 210 is configured to rectify AC current flowing though the load 110 and to communicate the rectified AC current to resistor R7 220. The value of resistor R10 230 may be matched to the impedance of the load 110. In one implementation, the impedance of the load 110 and resistance of resistor R10 230 are about 27 KOhms.

The exemplary component values describe above cooperate to advantageously produce a substantially constant peak-to-peak voltage of 160 Vp-p across the load 110 in the presence of significant variations in the peak-to-peak voltage provided by the power source 120. For example, the voltage across the load 110 may remain constant for power source 120 voltages between 160 Vp-p and 431 Vp-p, and even greater. The voltage across the load 110 may be adjusted by varying the component values. For example, the voltage across the load 110 may be increased by decreasing the resistance of resistor R9 245 and/or by selecting a zener diode D12 250 with a higher zener voltage. Conversely, the voltage across the load 110 may be decreased by increasing the resistance of resistor R9 245 and/or by selecting a zener diode D12 250 with a lower zener voltage. In one implementation, the respective values are chosen so that the voltage across the load 110 equals the lowest expected voltage produced by the power source 120.

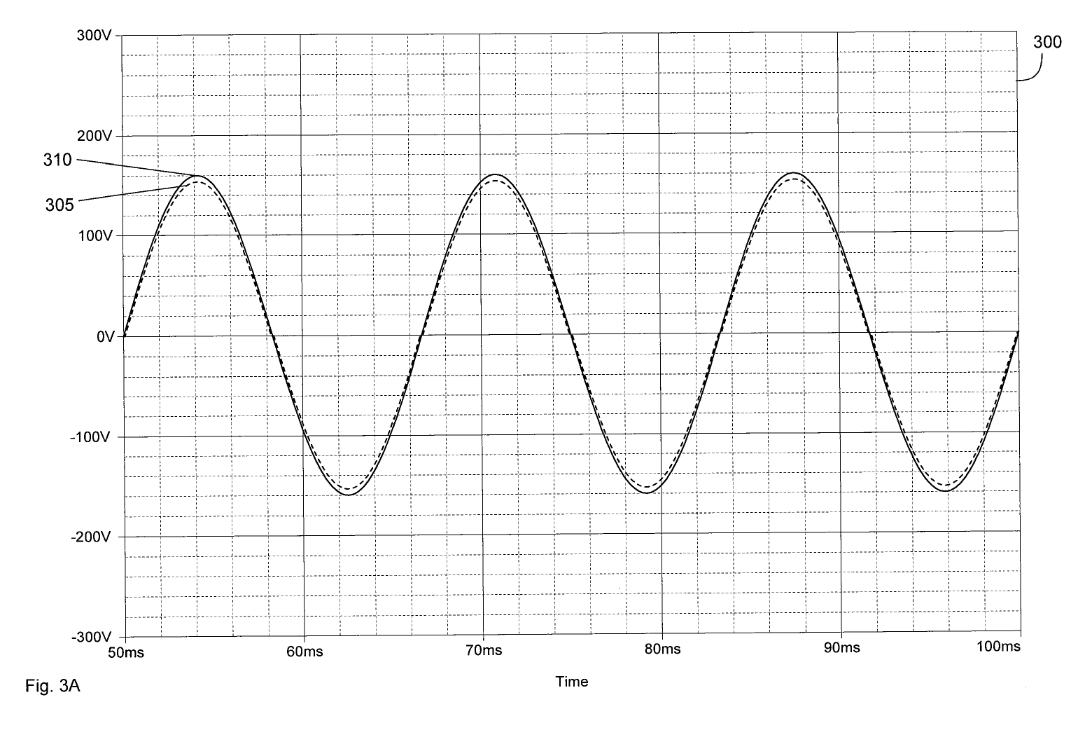

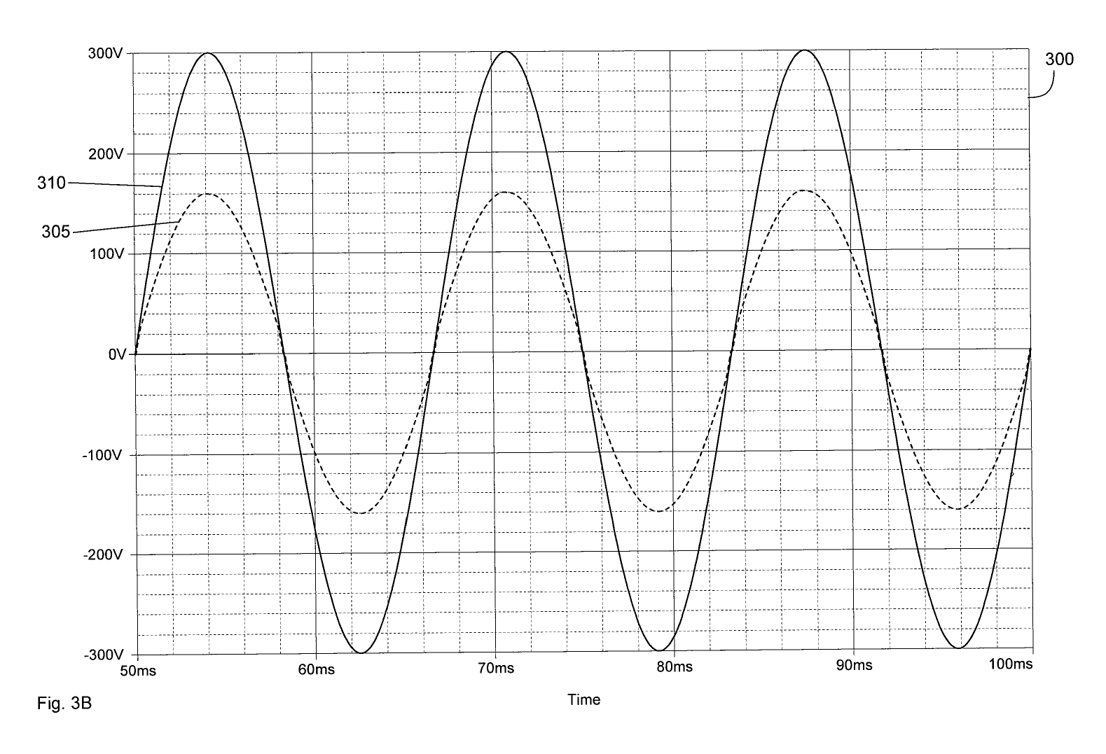

FIGS. 3A and 3B illustrate voltage waveforms of the exemplary voltage regulator of FIG. 2. Shown is a power source voltage waveform 310 that represents the voltage output from the power source 120 (FIG. 2). Also shown is a load voltage waveform 305 that represents the voltage across the load 110 (FIG. 2). As shown in FIG. 3A, when the peak-to-peak power source voltage 310 is approximately 160 Vp-p, the load voltage 305 is also about 160 Vp-p, or about the same as the power source voltage 310, and the respective voltage waveforms are nearly identical.

In FIG. 3B, the peak-to-peak power source voltage 310 is increased to approximately 300 Vp-p. As shown, the load voltage 305 remains substantially constant at about 160 Vp-p. As shown in both FIGS. 3A and 3B, the load voltage 305 remains sinusoidal in nature throughout variations in the power source voltage 310. Therefore, the RMS (root-mean-square) value of the load voltage 305 is also substantially constant over variations in the power source voltage 310. The peak-to peak and RMS values of the load voltage 305 remain substantially constant for even greater power source voltages 310, such as 431 Vp-p. Regulation of even higher power source voltages 310 may be is possible provided components capable of withstanding the higher voltages are selected.

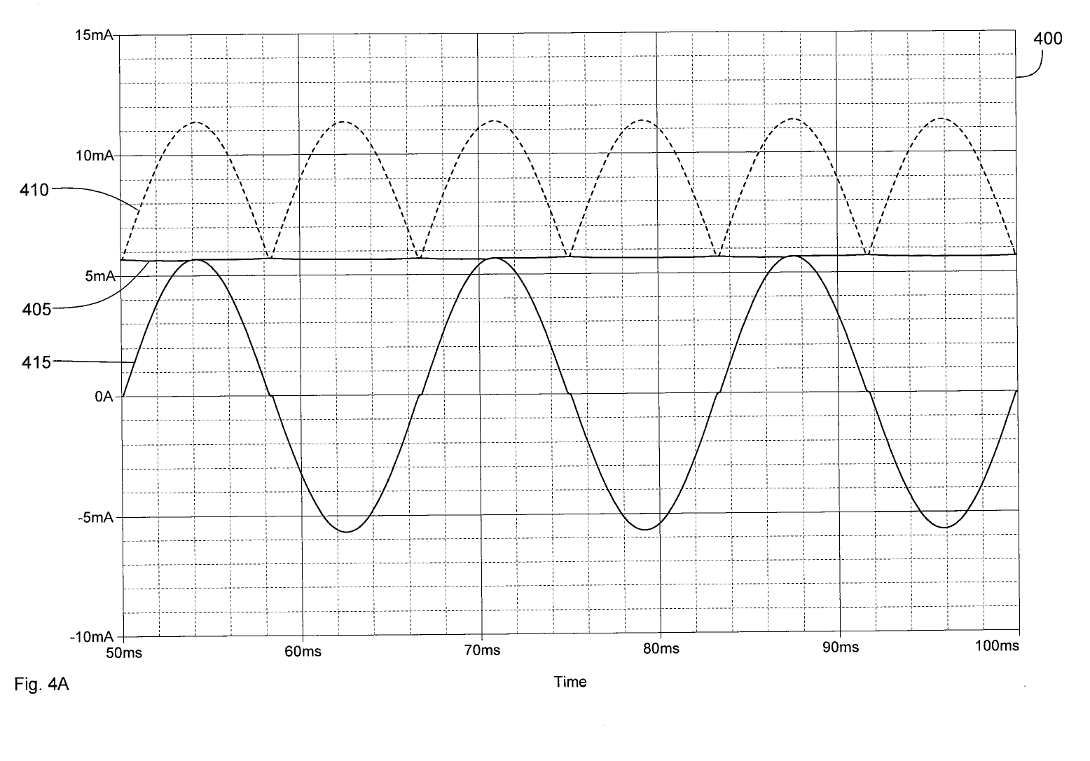

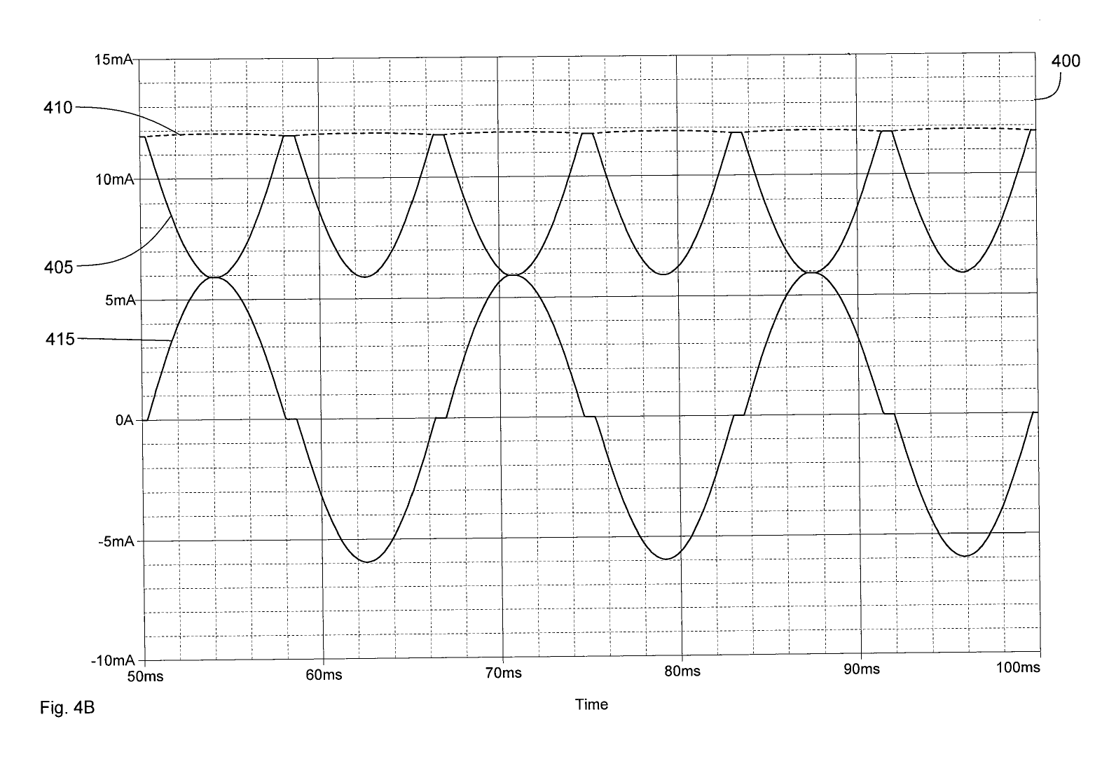

FIGS. 4A and 4B illustrate current waveforms of current flowing through the load 110 (FIG. 2), resistor R10 230 (FIG. 2), and collector of transistor Q1 240 (FIG. 2). The currents shown in FIGS. 4A and 4B coincide with the voltages shown in FIGS. 3A and 3B, respectively.

Referring to FIG. 4A, when the peak-to-peak voltage of the power source 110 is approximately equal to the desired voltage across the load 110, the current 405 flowing through resistor R10 230 is substantially constant. The current 410 flowing through the collector of transistor Q1 240 substantially equals the magnitude of the current flowing through the load 110. In this mode of operation, transistor Q1 240 may not be operating in a linear region.

Referring to FIG. 4B, as the peak-to-peak voltage of the power source 120 increases beyond the desired load 110 voltage, transistor Q1 240 enters a linear mode of operation. In this mode of operation, the current 410 flowing through the collector of transistor Q1 240 is substantially constant. As the magnitude of the current 415 flowing through the load 110 increases, the current 405 flowing through resistor R10 230 decreases by a corresponding amount, such that the sum of the two currents 405 and 415 equals the current 410 flowing through the collector of transistor Q1 240.

As described above, the exemplary voltage regulator circuit is able to maintain a substantially constant peak-to-peak voltage and RMS voltage across the load resistor in the presence of significant variations in the voltage provided by the power source. Moreover, the number of components is relatively low, enabling the voltage regulator circuit to fit within small confined spaces.

While the voltage regulator has been described with reference to certain component configurations and component values, it will be understood by those skilled in the art that various changes may be made and equivalents may be substituted without departing from the scope of the claims. For example, the values of the various components may be adjusted to increase or decrease the voltage provided across the load. Additionally, different types of components may be utilized. For example, a constant current source circuit that utilizes a JFET, MOSFET, or other transistor as the active component may be utilized. The voltage reference provided to the base of the transistor may be generated differently.

Moreover, although reference is made to various components being coupled to one another, it is to be understood that the components do not necessarily have to be directly coupled. For example, fuses and the like may be inserted between components without affecting the operation of the exemplary circuits. Capacitors and inductors may be inserted between components of the exemplary circuits to condition various voltages and currents of the circuit.

Many other modifications may be made to adapt a particular situation or material to the teachings without departing from its scope. Therefore, it is intended that the voltage regulator defined by the claims not be limited to the particular embodiment disclosed, but rather any circuit that falls within the scope of the claims.

I claim:

1. A voltage regulator comprising:
a constant current source circuit configured to regulate an alternating current flowing through a load such that a peak-to-peak voltage across the load remains substantially constant when a peak-to-peak voltage of an AC (alternating current) voltage source that provides power to the load varies.

2. The voltage regulator according to claim 1, wherein an RMS (root-mean-square) voltage across the load remains substantially constant.

3. The voltage regulator according to claim 1, wherein the load has a substantially constant impedance.

4. The voltage regulator according to claim 3, wherein the impedance is substantially resistive.

5. The voltage regulator according to claim 3, further comprising at least one resistor with a resistance that substantially matches the impedance of the load.

6. The voltage regulator according to claim 1, wherein the peak-to-peak voltage across the load remains substantially constant when the peak-to-peak voltage of the voltage source varies from about 160 Vp-p to 431 Vp-p.

7. A voltage regulator comprising:
a source port configured to be coupled to a power source;
a load port configured to be coupled to a load; and
a constant current source circuit in electrical communication with the source port and the load port configured to regulate current flowing between the source port and the load port, wherein current flows in both a positive direction and a negative direction between the source port and the load port, and the constant current source circuit regulates the current that flows in the positive direction and the current that flows in the negative direction.

8. The voltage regulator according to claim 7, wherein the voltage regulator regulates a peal-to-peak voltage across the load.

9. The voltage regulator according to claim 7, wherein the voltage regulator regulates an RMS (root-mean-square) voltage across the load.

10. The voltage regulator according to claim 7, wherein the load has a substantially constant impedance.

11. The voltage regulator according to claim 10, wherein the impedance is substantially a real value.

12. The voltage regulator according to claim 10, further comprising at least one resistor with a resistance that substantially matches the impedance of the load.

13. The voltage regulator according to claim 7, wherein the peak-to-peak voltage across the load remains substantially constant when the peak-to-peak voltage of the power source varies from about 160 Vp-p to 431 Vp-p.

14. A method for regulating a voltage across a load comprising:
providing:
a source port configured to be coupled to a power source;
a load port configured to be coupled to a load; and
a constant current source circuit in electrical communication with the source port and the load port configured to regulate current flowing between the source port and the load port, wherein current flows in both a positive direction and a negative direction between the source port and the load port, and the constant current source circuit regulates the current that flows in the positive direction and the current that flows in the negative direction;
coupling the source port to a power source configured to provide an AC (alternating current) voltage; and
coupling a load to the load port.

15. The method according to claim 14, wherein the voltage regulator regulates a peal-to-peak voltage across the load.

16. The method according to claim 14, wherein the voltage regulator regulates an RMS (root-mean-square) voltage across the load.

17. The method according to claim 14, wherein the load has a substantially constant impedance.

18. The method according to claim 17, wherein the impedance is substantially a real value.

19. The method according to claim 17, further comprising providing at least one resistor with a resistance that substantially matches the impedance of the load.

20. The method according to claim 14, wherein the peak-to-peak voltage across the load remains substantially constant when the peak-to-peak voltage of the power source varies from about 160 Vp-p to 431 Vp-p.
